(19) United States
(12) Patent Application Publication
(10) Pub. No.: US 2026/0315926 A1
(43) Pub. Date: Oct. 15, 2026

(54) Method and Device for Picking Up Game Rewards

(71) Applicant: Century Games Pte. Ltd., Singapore (SG)

(72) Inventors: CONGNAN HUANG, Singapore (SG); YE TIAN, Singapore (SG); ZENGXING LIAO, Singapore (SG); ZHIWEI FU, Singapore (SG)

(73) Assignee: Century Games Pte. Ltd., Singapore (SG)

(21) Appl. No.: 19/443,323

(22) Filed: Jan. 8, 2026

(30) Foreign Application Priority Data
Apr. 10, 2025 (CN) 202510450866.0

(51) Int. Cl. A63F 13/55; A63F 13/533; A63F 13/69

(52) U.S. Cl. CPC A63F 13/55; A63F 13/533; A63F 13/69

(57) ABSTRACT

A game reward collecting method includes switching, based on a stage event in a game, a game interaction mode from a first game interaction mode to a second game interaction mode, wherein a game interface remains unchanged during the switching; determining whether a player performs a reward pickup operation in a game scene of the first game interaction mode; displaying a game reward in a game scene of the second game interaction mode when the player does not perform the reward pickup operation in the game scene of the first game interaction mode; monitoring the reward pickup operation of the player in the game scene of the second game interaction mode; and issuing the game reward to the player in response to the reward pickup operation. The method enhances the correlation between different game scenes or modes, thereby improving players'gaming experience.

### PRIORITY CLAIMS

This application claims priority under the Paris Convention to Chinese Application CN 202510450866.0 filed on Apr. 10, 2025, and titled METHOD AND APPARATUS FOR PICKING UP GAME REWARD, the content of which is hereby incorporated by reference in its entirety.

### TECHNICAL FIELD

The present disclosure relates to the technical field of computer games, and in particular, relates to a method and apparatus for collecting rewards in a computer game.

### BACKGROUND

At present, simulation construction games, as an important type of games, have been successfully ported to mobile terminal devices such as mobile phones and tablets. To enrich gameplay and enhance interactivity with players, developers often incorporate tower defense gameplay into these simulation construction games.

However, in conventional multi-mode games, different gameplay modes often operate independently, resulting in a fragmented user experience for players. For example, the conventional tower defense gameplay is usually presented in the form of an instance in the simulation construction game. During the game, where players wish to engage in the tower defense gameplay, they need to switch from the main interface of the simulation construction game to the instance of the tower defense gameplay to play the corresponding tower defense game. This switching method leads to a fragmented player experience. In addition, the “scene-bound resource” mechanism commonly used in the related art results in a weak correlation of resources between different modes. Under this mechanism, game rewards (e.g., treasure chests, materials, and other game resources) generated in the tower defense gameplay, if not picked up in time during a tower defense battle scene, may either disappear permanently after the player returns to the main city, or require the player to re-enter the tower defense battle scene to continue pickup. This design severs the connection between combat rewards and management and construction aspects of the game, thereby undermining the strategic continuity of the players. In addition, the lack of dynamic interaction between different modes makes the game feel like disjointed combination of parts, which fails to sustain long-term engagement of the players.

Therefore, there is an urgent need for a technical solution to address the above defects in the related art.

### SUMMARY

The present disclosure is intended to provide a method and apparatus for picking up a game reward in a computer game, to improve the game experience for players.

According to an aspect of the present disclosure, a method of picking up a game reward is provided. The method includes: switching, based on a stage event in a game, a game interaction mode from a first game interaction mode to a second game interaction mode, wherein a game interface remains unchanged during switching of the game interaction mode; determining whether a player performs a reward pickup operation in a game scene of the first game interaction mode; in a case where the player does not perform the reward pickup operation in the game scene of the first game interaction mode, displaying the game reward in a game scene of the second game interaction mode; monitoring the reward pickup operation of the player in the game scene of the second game interaction mode; and issuing the game reward to the player in response to the reward pickup operation.

According to the above solution, the exemplary method according to the present disclosure avoids using an instance form during switching between the game interaction modes, and ensures that seamless switching of the game interaction modes is achieved without switching the current game interface, thereby significantly improving the integrity of the game and the immersion of the player. Moreover, the method further allows the player to pick up, in the second game interaction mode, a game reward that is not picked up in time in the first game interaction mode, which avoids the weak correlation of resources caused by the scene-bound resource mechanism, and enhances strategic continuity of the player across different game scenes or modes, thereby improving the game experience for the player.

In some embodiments, the method further includes: in a case where the player performs the reward pickup operation in the game scene of the first game interaction mode, issuing the game reward to the player in the first game interaction mode.

In some embodiments, the method further includes: in a case where a predetermined condition is satisfied, displaying, in the game scene of the first game interaction mode, a first icon corresponding to the game reward; monitoring whether a game character of the player moves into a reward pickup range with the first icon as a center; and issuing, in response to the game character moving into the reward pickup range, the game reward to the player in the first game interaction mode.

In some embodiments, the method further includes: displaying a second icon corresponding to the game reward in the game scene of the second game interaction mode; monitoring a touch operation of the player on the second icon; and issuing, in response to the touch operation, the game reward to the player in the second game interaction mode.

According to the above solutions, in the exemplary method according to the present disclosure, the player chooses to pick up the corresponding game reward by controlling the movement of the game character in the game scene of the first game interaction mode, or chooses to pick up the game reward after switching to the second game interaction mode. Moreover, even when the player forgets to pick up the game reward in the first game interaction mode, the game reward may be retained for the player to pick up in a subsequent game process. Therefore, the method enables the player to have an extended degree of freedom in the case of picking up the game reward, such that the player freely chooses which method to complete the pickup operation. Moreover, in the method, the game reward generated in the first game interaction mode may be displayed in the game scene of the second game interaction mode, which further enhances the correlation between the game interaction scenes, such that the player is immersed in the gameplay without experiencing a fragmented experience from switching between different scenes or modes, thereby improving the game experience.

In some embodiments, the method further includes: pre-configuring a game reward to at least one reward coordinate point in the game scene of the first game interaction mode; and determining, in a case where a condition for awarding a game reward is triggered, for example, the enemy combat unit is killed, a reward coordinate point closest to a triggering condition coordinate point, for example, a death coordinate point of the enemy combat unit with the death coordinate point as a center, and using a game reward pre-configured at the closest reward coordinate point as the game reward.

In some embodiments, the method further includes: pre-calculating a probability of triggering a game reward after an enemy combat unit is killed and allocation weights of different game rewards; and pre-configuring, according to the allocation weights, the different game rewards to at least one reward coordinate point in the game scene of the first game interaction mode.

In some embodiments, the method further includes: uploading the closest reward coordinate point and a pickup state of a game reward corresponding to the closest reward coordinate point to a server, wherein a local client does not need to wait for a response to the uploading from the server.

In some embodiments, the method further includes: displaying, in a case where the enemy combat unit is killed, a reward appearance special effect in a parabolic trajectory, wherein the parabolic trajectory starts from the death coordinate point and ends at the closest reward coordinate point.

In some embodiments, the first game interaction mode is a tower defense battle mode, and the second game interaction mode is a main city construction mode of the player.

According to the above solutions, in the exemplary method according to the present disclosure, by means of allocating rewards with uncertainty to the kill operation of the player in the game according to a predetermined rule, the fun of the game is effectively enhanced, thereby stimulating the enthusiasm of the player for the game. Herein, that an enemy combat unit is killed is used as an example of the triggering condition for awarding a game reward Moreover, by means of displaying reward appearance special effects in game scenes, corresponding visual game feedback can be provided to the player, such that the player can intuitively grasp the current game progress and state, and the fun of the game can be further enhanced, thereby improving the game experience for the player.

According to another aspect of the present disclosure, further provided is an apparatus for picking up a reward. The apparatus includes a memory and one or more processors. The apparatus further includes: a switching module, configured to switch, based on a stage event in a game, a game interaction mode from a first game interaction mode to a second game interaction mode, wherein a game interface remains unchanged during switching of the game interaction mode; a monitoring module, configured to determine whether a player performs a reward pickup operation in a game scene of the first game interaction mode, and monitor the reward pickup operation of the player in a game scene of a second game interaction mode; a reward display module, configured to display the reward in the game scene of the second game interaction mode; and a reward issuing module, configured to issue, in response to the reward pickup operation of the player in the game scene of the second game interaction mode, the reward to the player. It is noted that term “module” may refer to hardware, software, or a combination of hardware and software. For example, a module may be implemented on one or more processors or one or more circuits.

### BRIEF DESCRIPTION OF DRAWINGS

For a better understanding of the above and other objectives, features, advantages and functions of the present disclosure, reference may be made to preferred embodiments shown in the accompanying drawings. The same reference numerals in the accompanying drawings denote the same parts. It should be understood by those skilled in the art that the accompanying drawings are intended to schematically illustrate the preferred embodiments of the present disclosure without any limitation on the scope of the present disclosure, and the various components in the drawings are not drawn to scale.

FIG. 1 is a flowchart of a method for picking up a game reward according to some embodiments of the present disclosure;

FIG. 2 is a flowchart of a method for picking up a game reward according to some embodiments of the present disclosure;

FIG. 3 is a flowchart of a method for picking up a game reward according to some embodiments of the present disclosure;

FIG. 4 is a flowchart of a method for picking up a game reward according to some embodiments of the present disclosure;

FIG. 5 is a flowchart of a method for picking up a game reward according to some embodiments of the present disclosure;

FIG. 6 is a flowchart of a method for picking up a game reward according to some embodiments of the present disclosure;

FIG. 7 is a flowchart of a method for picking up a game reward according to some embodiments of the present disclosure;

FIG. 8 is a flowchart of a method for picking up a game reward according to some embodiments of the present disclosure; and

FIG. 9 is a schematic diagram of an apparatus for picking up a game reward according to some embodiments of the present disclosure.

### DETAILED DESCRIPTION

Specific embodiments of the present disclosure are described hereinafter in detail with reference to the accompanying drawings. The descriptions here are merely preferred embodiments of the present disclosure, and on the basis of the preferred embodiments, those skilled in the art would have been able to conceive of other ways to implement the present disclosure, and the other ways also fall within the scope of the present disclosure.

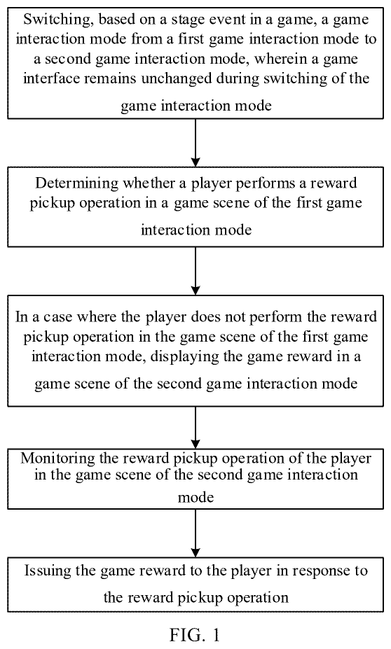

As illustrated in FIG. 1, in the embodiments of the present disclosure, a method for picking up a game reward includes: switching, based on a stage event in a game, a game interaction mode from a first game interaction mode to a second game interaction mode, wherein a game interface remains unchanged during switching of the game interaction mode; determining whether a player performs a reward pickup operation in a game scene of the first game interaction mode; in a case where the player does not perform the reward pickup operation in the game scene of the first game interaction mode, displaying the game reward in a game scene of the second game interaction mode; monitoring the reward pickup operation of the player in the game scene of the second game interaction mode; and issuing the game reward to the player in response to the reward pickup operation.

In the embodiments, the first game interaction mode is a tower defense battle mode, and the second game interaction mode is a main city construction mode of the player. In a game scene of the main city construction mode, the main city of the player may be displayed completely or at least partially. Alternatively, the first game interaction mode and the second game interaction mode may be interchanged.

It should be understood that both the main city construction mode and the tower defense battle mode are exemplary rather than limiting. That is, in the exemplary method according to the present disclosure, the game interaction mode may be any mode suitable for the player to engage in and interact with.

In the method, the game reward may be displayed in a specific area or at a specific position in the home city interface of the player. In addition, the game reward may be displayed in a sub-interface under the main city interface. For example, the main city interface of the player includes a sub-interface that is capable of displaying display information related to a tower defense battle, and a game reward that is not picked up in time in the tower defense battle is displayed in the sub-interface. In the main city interface or the sub-interface of the main city interface, the game reward may be displayed in the above interface in the form of a reward icon.

The stage event in the method may be an event of entering or exiting a game stage. The stage event may be actively selected by the player or automatically triggered based on a predetermined condition. As an example, the game stage includes at least one of a story stage, an event stage, a regular stage, or an endless challenge stage.

Therefore, the exemplary method according to the present disclosure avoids using an instance form during switching between the game interaction modes, and ensures that seamless switching of the game interaction modes is achieved without switching the current game interface, thereby significantly improving the integrity of the game and the immersion of the player. Moreover, the method further allows the player to pick up, in the second game interaction mode, a game reward that is not picked up in time in the first game interaction mode, which avoids the weak resource correlation caused by the scene-bound resource mechanism, and enhances the strategic continuity of the player across different game scenes or modes, thereby improving the game experience for the player.

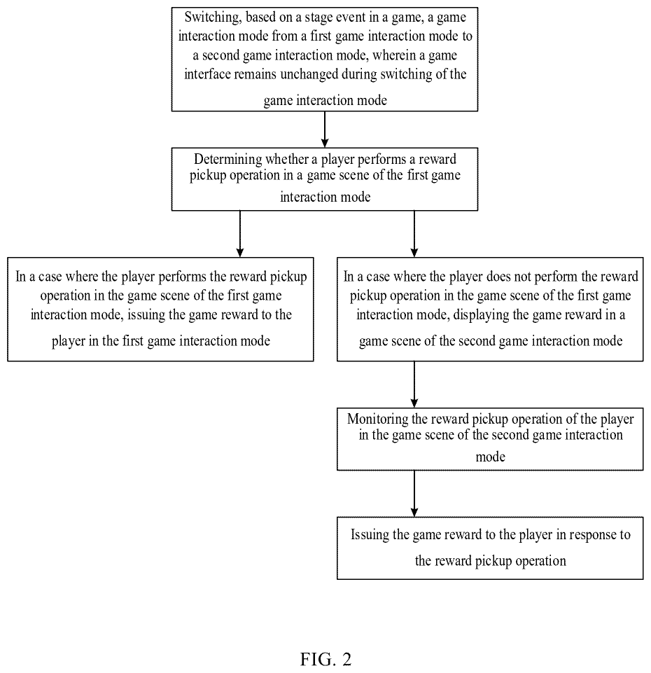

As illustrated in FIG. 2, in the exemplary method according to the present disclosure, the player may also directly pick up the game reward in the game scene of the first game interaction mode, thereby obtaining the game reward. Therefore, the method further includes: in a case where the player performs the reward pickup operation in the game scene of the first game interaction mode, issuing the game reward to the player in the first game interaction mode.

It should be understood that in a case where the player chooses to pick up the game reward in the game scene of the first game interaction mode and performs the corresponding reward pickup operation, the game reward is no longer displayed in the game scene of the second game interaction mode. The game reward may be issued to the player immediately after the player performs the corresponding reward pickup operation, or may be issued to the player separately or together with other rewards when the first game interaction mode ends.

In some embodiments, the game reward is triggered only in a case where the game satisfies certain conditions. Moreover, in a case where the game reward is triggered, the player needs to perform some specific reward pickup operations to obtain the game reward.

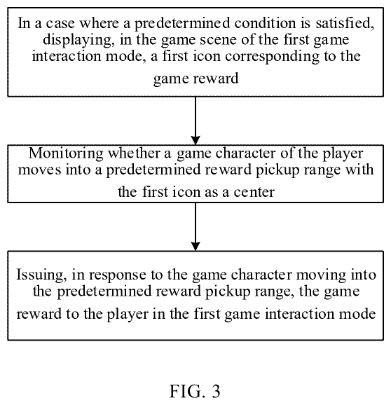

Therefore, as illustrated in FIG. 3, the method further includes: in a case where a predetermined condition is satisfied, displaying, in the game scene of the first game interaction mode, a first icon corresponding to the game reward; monitoring whether a game character of the player moves into a predetermined reward pickup range with the first icon as a center; and issuing, in response to the game character moving into the predetermined reward pickup range, the game reward to the player in the first game interaction mode.

In the above exemplary method, the predetermined condition for triggering the game reward and displaying the game reward in the game scene of the first game interaction mode is the death of an enemy combat unit. For example, in a tower defense battle, in a case where the game character of the player kills an enemy combat unit, the game reward is either certainly or with a certain probability. In addition, the method may further include other predetermined conditions for triggering the game reward. The game reward may be displayed in the game scene of the first game interaction mode in the form of an icon, for example, in the form of a treasure chest.

In a case where the game reward is triggered and the first icon corresponding to the game reward is displayed in the game scene of the first game interaction mode, the player needs to move the game character into a predetermined range to trigger the game reward pickup operation.

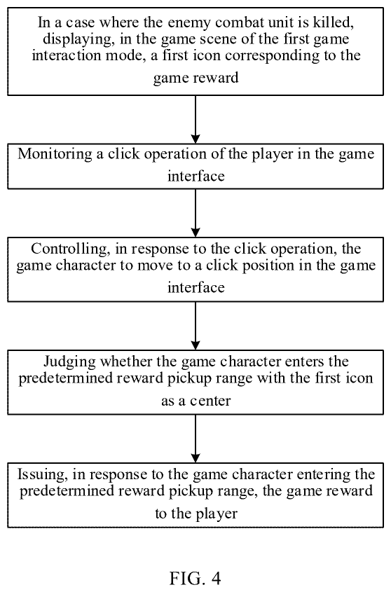

As illustrated in FIG. 4, in some embodiments, the player clicks the first icon in the game interface, such that the game character automatically navigates to the position of the first icon based on the click operation of the player. in a case where the game character enters the predetermined reward pickup range with the first icon as a center, the game reward pickup operation is triggered.

Therefore, the exemplary method according to the present disclosure includes: in a case where the enemy combat unit is killed, displaying, in the game scene of the first game interaction mode, a first icon corresponding to the game reward; monitoring a click operation of the player in the game interface; controlling, in response to the click operation, the game character to move to a click position in the game interface; judging whether the game character enters the predetermined reward pickup range with the first icon as a center; and issuing, in response to the game character entering the predetermined reward pickup range, the game reward to the player.

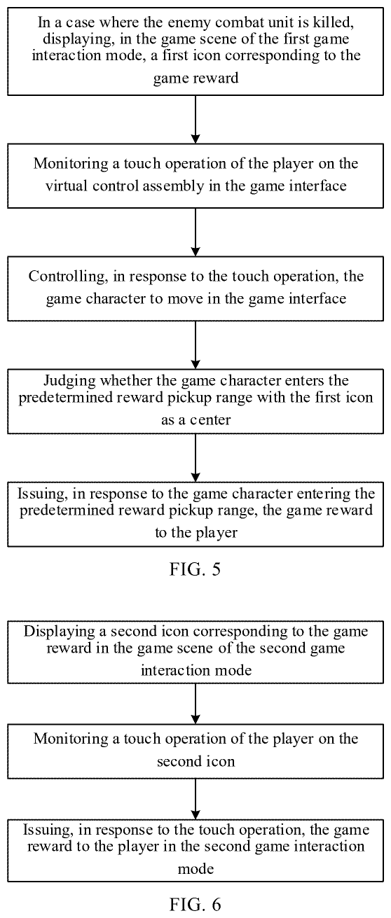

As illustrated in FIG. 5, in some embodiments, the player moves the game character to the predetermined reward pickup range with the first icon as a center by controlling a virtual control assembly (e.g., a virtual joystick) in the game interface, thereby triggering the game reward pickup operation.

Therefore, the exemplary method according to the present disclosure further includes: in a case where the enemy combat unit is killed, displaying, in the game scene of the first game interaction mode, a first icon corresponding to the game reward; monitoring a touch operation of the player on the virtual control assembly in the game interface; controlling, in response to the touch operation, the game character to move in the game interface; judging whether the game character enters the predetermined reward pickup range with the first icon as a center; and issuing, in response to the game character entering the predetermined reward pickup range, the game reward to the player.

The two reward pickup operations in the above embodiments are merely exemplary, and do not indicate that the method only adopts either one or both of the two pickup ways. The exemplary method according to the present disclosure may also adopt other suitable pickup ways.

In the method, the game reward pickup operation is triggered only in a case where the game character of the player enters the predetermined reward pickup range, and other combat units except the game character cannot trigger the pickup operation even if they come into contact with the predetermined reward pickup range.

As described above, referring to FIG. 6, in the exemplary method according to the present disclosure, the player continues to pick up, in the game scene of the second game interaction mode, the game reward that is not picked up in time in the first game interaction mode. Therefore, the method further includes: displaying a second icon corresponding to the game reward in the game scene of the second game interaction mode; monitoring a touch operation of the player on the second icon; and issuing, in response to the touch operation, the game reward to the player in the second game interaction mode.

In the method, the second icon may be displayed in the game scene of the second game interaction mode in the form of a treasure chest. Moreover, the second icon may be the same as or different from the first icon displayed in the game scene of the first game interaction mode.

In a case where the game is in the second game interaction mode, the player may click the second icon in the game scene, and the method may respond to the click operation of the player and issue the corresponding game reward to the player.

In the method, the player chooses to pick up the corresponding game reward by controlling the movement of the game character in the game scene of the first game interaction mode, or chooses to pick up the game reward after returning to the second game interaction mode. Moreover, even if the player forgets to pick up the game reward in the first game interaction mode, the game reward will be retained for the player to continue picking up in a subsequent game process. It can be seen that the method enables the player to have an extended degree of freedom in the case of picking up the game reward, such that the player can freely choose which way to complete the pickup operation. Moreover, in the method, the game reward generated in the first game interaction mode may be displayed in the game scene of the second game interaction mode, which further enhances the correlation between the game interaction scene, such that the player is immersed in the gameplay without experiencing a fragmented experience from switching between different scenes or modes, thereby improving the game experience.

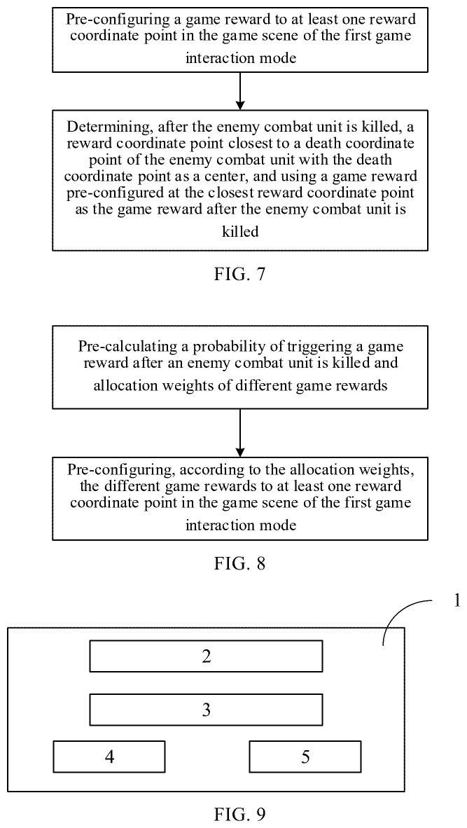

In addition, as illustrated in FIG. 7, in the exemplary method according to the present disclosure, the game reward may further be generated based on a predetermined rule. The method further includes: pre-configuring a game reward to at least one reward coordinate point in the game scene of the first game interaction mode; and determining, in a case where the enemy combat unit is killed, a reward coordinate point closest to a death coordinate point of the enemy combat unit with the death coordinate point as a center, and using a game reward pre-configured at the closest reward coordinate point as the game reward.

The operation of pre-configuring the game reward may be completed in a case where the first game interaction mode starts, or may be completed during the ongoing process of the first game interaction mode. The death coordinate point of the enemy combat unit refers to a coordinate point of the enemy combat unit in the game interface in a case where the enemy combat unit is killed by the game character of the player.

The embodiments are now described in detail by taking the tower defense battle mode as an example.

Referring to FIG. 8, in a case where the tower defense battle starts, a probability of triggering a game reward in the current tower defense battle and allocation weights of game rewards of different stages or quality types are pre-calculated. The corresponding game rewards are pre-configured to different reward coordinate points in the game scene of the tower defense battle according to the calculated allocation weights. After the game character of the player kills the enemy combat unit, whether the game reward is triggered by the current kill is determined based on the pre-calculated probability. In a case where the game reward is determined to be triggered, the pre-configured reward coordinate point closest to the death coordinate point of the enemy combat unit is determined with the death coordinate point of the enemy combat unit as a center, and the game reward previously configured to the reward coordinate point based on the calculated issuing weights is used as the game reward for the current kill.

The above calculation operation may be directly completed by the local client or by the server. In a case where the above calculation operation is performed by the server, the server issues a calculation result to the local client.

The method further includes recording the above reward coordinate point for triggering the game reward and the corresponding game reward pickup state. For example, in a case where the player does not pick up the game reward in the tower defense battle mode, the pickup state of the game reward is recorded as not picked up; in a case where the player picks up the game reward in the tower defense battle mode, the pickup state of the game reward is recorded as picked up. The game reward that has been picked up cannot be picked up again.

The record information about the reward coordinate point and the pickup state may be uploaded to the server. Moreover, in a case where the tower defense battle is in progress, the local client does not need to wait for a response to the uploading from the server, thereby ensuring the continuity and fluency of the tower defense game.

In a case where the player does not pick up the game reward in the tower defense battle mode, the game reward is displayed in the game scene of the main city construction mode, for example, in the main city interface, such that the player continues picking up the game reward in the game scene. Further, based on the recorded reward coordinate point and pickup state related to the game reward, the first icon corresponding to the game reward may be further displayed in the game scene of the tower defense battle mode. Therefore, the player may also return to the game scene of the tower defense battle mode to continue picking up the game reward.

In addition, in some embodiments, the exemplary method according to the present disclosure further includes: displaying, in a case where the enemy combat unit is killed, a reward appearance special effect in a parabolic trajectory, wherein the parabolic trajectory starts from the death coordinate point of the enemy combat unit and ends at the closest reward coordinate point.

The method further includes: upon displaying the reward appearance special effect, generating a first icon corresponding to the respective game reward at the closest reward coordinate point. In the process of generating the first icon, the corresponding generated special effect may also be displayed synchronously.

In addition, in the method, in a case where the enemy combat unit is killed and before the reward appearance special effect is displayed, the death special effect of the enemy combat unit may further be displayed at the death coordinate point, for example, by playing a death animation of the enemy combat unit. The death special effect and the reward appearance special effect may be simultaneously displayed in the game. Alternatively, the death special effect may be displayed first, and upon completion of the death special effect, the reward appearance special effect may then be displayed.

By means of allocating game rewards with uncertainty to the kill operation of the player in the game according to a predetermined rule, the fun of the game can be effectively enhanced, thereby stimulating the enthusiasm of the player for the game. Moreover, by means of displaying death special effects, reward appearance special effects and spawn effects in game scenes, corresponding visual game feedback may be provided to the player, such that the player intuitively grasps the current game progress and state, and the fun of the game is further enhanced, thereby improving the game experience for the player.

Referring to FIG. 9, the present disclosure further provides an apparatus 1 for picking up a game reward. The apparatus 1 includes: a switching module 2, configured to switch, based on a stage event in a game, a game interaction mode from a first game interaction mode to a second game interaction mode, wherein a game interface remains unchanged during switching of the game interaction mode; a monitoring module 3, configured to determine whether a player performs a reward pickup operation in a game scene of the first game interaction mode, and monitor the reward pickup operation of the player in a game scene of a second game interaction mode; a reward display module 4, configured to display a game reward in the game scene of the second game interaction mode; and a reward issuing module 5, configured to issue, in response to the reward pickup operation of the player in the game scene of the second game interaction mode, the game reward to the player. In some embodiments, the different modules may represent hardware or hardware configured with software.

The above description of various embodiments of the present disclosure is provided for purposes of description to those of ordinary skill in the related art. The present disclosure is not intended to be exclusive or limited to a single disclosed embodiment. As above, many alternatives and variations of the present disclosure may be apparent to those of ordinary skill in the art from the above teachings. Therefore, although some alternative embodiments are specifically described, other embodiments may be apparent to or relatively easily developed by those of ordinary skill in the art. The present disclosure is intended to encompass all alternatives, modifications and variations of the present disclosure described here, and other embodiments falling within the spirit and scope of the present disclosure described above.

What is claimed is:

1. A method for collecting a game reward, comprising:
switching, based on a stage event in a game, a game interaction mode from a first game interaction mode of the game to a second game interaction mode of the game, wherein a game interface remains unchanged during switching of the game interaction mode;
determining whether a player performs a reward pickup operation in a game scene of the first game interaction mode;
when the player does not perform the reward pickup operation in the game scene of the first game interaction mode, displaying a game reward in a game scene of the second game interaction mode;
monitoring the reward pickup operation of the player in the game scene of the second game interaction mode; and
issuing the game reward to the player in response to the reward pickup operation;
the method further comprises:
pre-calculating a probability of triggering a game reward after a triggering condition is met and allocation weights of different game rewards;
pre-configuring, according to the allocation weights, the different game rewards to at least one reward coordinate point in the game scene of the first game interaction mode; and
determining, after the triggering condition is met, a reward coordinate point closest to a triggering condition coordinate point with the triggering condition coordinate point as a center, and using a game reward pre-configured at the closest reward coordinate point as the game reward for the triggering condition.

2. The method according to claim 1, wherein the method further comprises:
when the player performs the reward pickup operation in the game scene of the first game interaction mode, issuing the game reward to the player in the first game interaction mode.

3. The method according to claim 2, wherein the method further comprises:
when a predetermined condition is satisfied, displaying, in the game scene of the first game interaction mode, a first icon corresponding to the game reward;
monitoring whether a game character of the player moves into a reward pickup range with the first icon as a center; and
issuing, in response to the game character moving into the reward pickup range, the game reward to the player in the first game interaction mode.

4. The method according to claim 1, wherein the method further comprises:
displaying a second icon corresponding to the game reward in the game scene of the second game interaction mode;
monitoring a touch operation of the player on the second icon; and
issuing, in response to the touch operation, the game reward to the player in the second game interaction mode.

5. The method according to claim 1, wherein the method further comprises:
uploading the closest reward coordinate point and a pickup state of a game reward corresponding to the closest reward coordinate point to a server, wherein a local client does not need to wait for a response to the uploading from the server.

6. The method according to claim 1, wherein the method further comprises:
displaying, after the triggering condition is met, a reward appearance special effect in a parabolic trajectory, wherein the parabolic trajectory starts from the triggering condition coordinate point and ends at the closest reward coordinate point.

7. The method according to claim 1, wherein the first game interaction mode is a tower defense battle mode, and the second game interaction mode is a main city construction mode of the player.

8. The method according to claim 1, wherein the triggering condition for triggering the game reward is an enemy combat unit is killed and the triggering condition coordinate point is a death coordinate point.

9. An apparatus for picking up a game reward, comprising a memory and one or more processors, wherein the apparatus comprises:
a switching module implemented in the one or more processors, configured to switch, based on a stage event in a game, a game interaction mode from a first game interaction mode of the game to a second game interaction mode of the game, wherein a game interface remains unchanged during switching of the game interaction mode;
a monitoring module implemented in the one or more processors, configured to determine whether a player performs a reward pickup operation in a game scene of the first game interaction mode, and monitor the reward pickup operation of the player in a game scene of the second game interaction mode;
a reward display module implemented in the one or more processors, configured to display the game reward in the game scene of the second game interaction mode; and
a reward issuing module implemented in the one or more processors, configured to issue, in response to the reward pickup operation of the player in the game scene of the second game interaction mode, the game reward to the player, and further configured to pre-calculate a probability of triggering a game reward after a triggering condition is met and allocation weights of different game rewards, pre-configure, according to the allocation weights, the different game rewards to at least one reward coordinate point in the game scene of the first game interaction mode, and determine, when the triggering condition is met, a reward coordinate point closest to a triggering condition coordinate point with the triggering condition coordinate point as a center, and using a game reward pre-configured at the closest reward coordinate point as the game reward for the triggering condition.

10. The apparatus according to claim 9, wherein when the player performs the reward pickup operation in the game scene of the first game interaction mode, the game reward is issued to the player in the first game interaction mode.

11. The apparatus according to claim 10, wherein
when a predetermined condition is satisfied, the reward display module is further configured to display in the game scene of the first game interaction mode, a first icon corresponding to the game reward;
the monitoring module is further configured to monitor whether a game character of the player moves into a reward pickup range with the first icon as a center; and
the reward issuing module is further configured to issue, in response to the game character moving into the reward pickup range, the game reward to the player in the first game interaction mode.

12. The apparatus according to claim 9, wherein
the reward display module is further configured to display a second icon corresponding to the game reward in the game scene of the second game interaction mode;
the monitoring module is further configured to monitor a touch operation of the player on the second icon; and
the reward issuing module is further configured to issue, in response to the touch operation, the game reward to the player in the second game interaction mode.

13. The apparatus according to claim 9, wherein the closest reward coordinate point and a pickup state of a game reward corresponding to the closest reward coordinate point are uploaded to a server, and a local client does not need to wait for a response to the uploading from the server.

14. The apparatus according to claim 9, wherein
the reward display module is further configured to display, after the triggering condition is met, a reward appearance special effect in a parabolic trajectory, wherein the parabolic trajectory starts from the triggering condition coordinate point and ends at the closest reward coordinate point.

15. The apparatus according to claim 9, wherein the first game interaction mode is a tower defense battle mode, and the second game interaction mode is a main city construction mode of the player.

16. The apparatus according to claim 9, wherein the triggering condition for triggering the game reward is that an enemy combat unit is killed and the triggering condition coordinate point is a death coordinate point.
